(19) United States
(12) Patent Application Publication
(10) Pub. No.: US 2019/0051171 A1
(43) Pub. Date: Feb. 14, 2019

(54) SYSTEM AND METHOD FOR MANAGING TRAFFIC BY PROVIDING RECOMMENDATIONS TO CONNECTED OBJECTS

(71) Applicant: Gridsmart Technologies, Inc., Knoxville, TN (US)

(72) Inventors: William A. Malkes, Knoxville, TN (US); William S. Overstreet, Knoxville, TN (US); Jeffery R. Price, Knoxville, TN (US); Michael J. Tourville, Lenoir City, TN (US)

(21) Appl. No.: 16/058,106

(22) Filed: Aug. 8, 2018

Related U.S. Application Data
(60) Provisional application No. 62/544,544, filed on Aug. 11, 2017.

(51) Int. Cl. G08G 1/0967; H04W 4/024; H04W 4/46; G08G 1/01; G08G 1/0968

(52) U.S. Cl. CPC G08G 1/096725; H04W 4/024; H04W 4/46; G08G 1/096855; G08G 1/0145; G08G 1/0125; G08G 1/012

(57) ABSTRACT

A traffic control system and a method for managing traffic by providing recommendations to vehicles are disclosed. One aspect of the present disclosure is a method of adaptive traffic control including detecting an object at an intersection; determining at least one destination associated with the object; based on at least one traffic flow rate at the intersection and the at least one destination, determining a suggestion for the object, the suggestion including one of (1) at least one alternative destination and a corresponding travel route or (2) at least one alternative route to the at least one destination; selecting a corresponding promotion for the suggestion; and communicating, as a recommendation, the suggestion and the corresponding promotion to the object.

### CROSS-REFERENCE TO RELATED APPLICATIONS

This application claims priority to U.S. Provisional Patent Application No. 62/544,544 filed on Aug. 11, 2017, the entire content of which is incorporated herein by reference.

### FIELD OF THE DISCLOSURE

The present disclosure is generally related to traffic control systems, and more particularly related to managing traffic by providing recommendations to detected objects and vehicles.

### BACKGROUND

Control of vehicular traffic on roads is essential for the transportation of persons and goods. Typically, vehicular traffic is controlled by traffic control systems. The traffic control systems regulate flow of traffic at intersections. Generally, three different lights are mounted on a traffic signal indicator present at the intersections. The three lights are used to regulate the movement of traffic coming and going through all of the roads. In cities, the amount of traffic is vast and leads to traffic congestion. In one case, the traffic congestion is caused due to overloaded infrastructure.

Currently, in order to mitigate traffic congestion, various mechanisms such as remote traffic control systems may be employed. In some remote traffic control systems, an operator may select from a set of preset signal timing patterns based on the number of vehicles present on each road of the intersection from inspection of a video feed provided by a surveillance camera at the intersection. Such manual operation often fails to fully remedy inefficiency, as inappropriate distribution of movement time (a few seconds) on any road aggravates the traffic condition.

Despite providing such mechanisms, the traffic control systems fail to avoid traffic congestion, particularly during peak hours and during inclement weather. With the advancements in interconnected cars, there is room to further improve traffic conditions and avoid congestions.

### SUMMARY

One or more example embodiments of inventive concepts are directed to managing traffic at intersections by providing recommendations and incentives to objects at the intersection to take alternative routes to their respective destinations.

One aspect of the present disclosure is a method of adaptive traffic control including detecting an object at an intersection; determining at least one destination associated with the object; based on at least one traffic flow rate at the intersection and the at least one destination, determining a suggestion for the object, the suggestion including one of (1) at least one alternative destination and a corresponding travel route or (2) at least one alternative route to the at least one destination; selecting a corresponding promotion for the suggestion; and communicating, as a recommendation, the suggestion and the corresponding promotion to the object.

One aspect of the present disclosure is a traffic controller with memory having computer-readable instructions stored thereon and one or more processors. The one or more processors are configured to execute the computer-readable instructions to detect an object at an intersection; determine at least one destination associated with the object; based on at least one traffic flow rate at the intersection and the at least one destination, determine a suggestion for the object, the suggestion including one of (1) at least one alternative destination and a corresponding travel route or (2) at least one alternative route to the at least one destination; select a corresponding promotion for the suggestion; and communicate, as a recommendation, the suggestion and the corresponding promotion to the object.

One aspect of the present disclosure includes one or more non-transitory computer-readable medium having computer-readable instructions stored thereon, which when executed by one or more processors, cause the one or more processors to detect an object at an intersection; determine at least one destination associated with the object; based on at least one traffic flow rate at the intersection and the at least one destination, determine a suggestion for the object, the suggestion including one of (1) at least one alternative destination and a corresponding travel route or (2) at least one alternative route to the at least one destination; select a corresponding promotion for the suggestion; and communicate, as a recommendation, the suggestion and the corresponding promotion to the object.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a system for controlling traffic;

FIG. 2 is a block diagram showing different components of the traffic controller of FIG. 1;

FIG. 3 is a block diagram showing different components of the light controller of FIG. 1;

FIG. 4 illustrates a flowchart of a method executed by the traffic controller of FIG. 1; and

FIG. 5 illustrates an example of a traffic flow rate table for an intersection.

### DETAILED DESCRIPTION

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

Example embodiments of the present disclosure will be described more fully hereinafter with reference to the accompanying drawings in which like numerals represent like elements throughout the several figures, and in which example embodiments are shown. Example embodiments of the claims may, however, be embodied in many different forms and should not be construed as limited to the example embodiments set forth herein. The examples set forth herein are non-limiting examples and are merely examples among other possible examples.

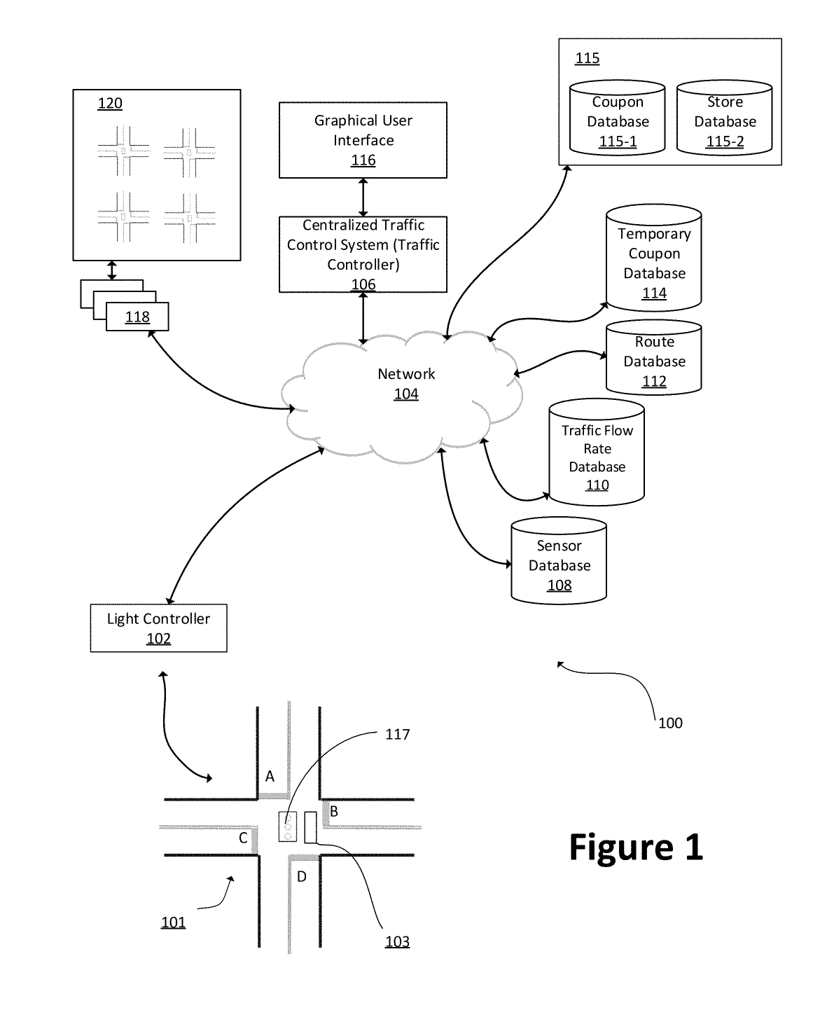

FIG. 1 illustrates a system for controlling traffic. The system 100 can comprise various components including but not limited to, a traffic light controller 102 (hereinafter may be referred to as a light controller 102) associated with a smart traffic camera 103 and a traffic light 117 installed at an intersection 101. The light controller 102 may be configured to receive traffic control rules from a traffic controller 106 and control the traffic light 117 to implement the same. The light controller 102 may or may not be physically located near (or at the same location as) the smart traffic camera 103 and/or the traffic light 117. The light controller 102, the smart traffic camera 103 and/or the traffic light 117 may be the same physical unit implementing functionalities of both. There may be more than one smart traffic camera 103 and/or traffic light 117 installed at the intersection 101.

In one example embodiment, the traffic light 117 associated with the light controller 102 can have different traffic signals directed towards all the roads/zones leading to the intersection 101. The different signals may comprise a Red light, a Yellow light, and a Green light.

The smart traffic camera 103 may be one of various types of cameras, including but not limited, to fisheye traffic cameras to detect and optimize traffic flows at the intersection 101 and/or at other intersection apart of the same local network or corridor. The smart traffic camera 103 can include any combination of cameras or optical sensors, such as but not limited to fish-eye cameras, directional cameras, infrared cameras, etc. The smart traffic camera 103 can allow for other types of sensors (e.g., audio sensors, temperature sensors, etc.) to be connected thereto (e.g., via various known or to be developed wired and/or wireless communication schemes) for additional data collection. The smart traffic camera 103 can collect video and other sensor data at the intersection 101 and convey the same to the light controller 102 for further processing, as will be described below.

The smart traffic camera 103 and/or the traffic light 117 can be used to manage and control traffic for all zones (directions) at which traffic enters and exits the intersection 101. Examples of different zones of the intersection 101 are illustrated in FIG. 1 (e.g., zones A, B, C and D). Therefore, while FIG. 1 only depicts a single smart traffic camera 103 and a single traffic light 117, there can be multiple ones of the smart traffic camera 103 and/or multiple ones of traffic lights 117 installed at the intersection 101 for managing traffic for different zones of the intersection 101.

The system 100 may further include network 104. The network 104 can enable the light controller 102 to communicate with the traffic controller 106 (a remote traffic control system 106). The network 104 can be any known or to be developed cellular, wireless access network and/or a local area network that enables communication (wired or wireless) among components of the system 100. The light controller 102 and the traffic controller 106 can communicate via the network 104 to exchange data, created traffic rules or control settings, etc., as will be described below.

The remote traffic control system 106 can be a centralized system used for managing and controlling traffic lights and conditions at multiple intersections (in a given locality, neighborhood, an entire town, city, state, etc.). The remote traffic control system 106 can also be referred to as the centralized traffic control system 106, the traffic control system 106 or simply the traffic controller 106, all of which can be used interchangeably throughout the present disclosure.

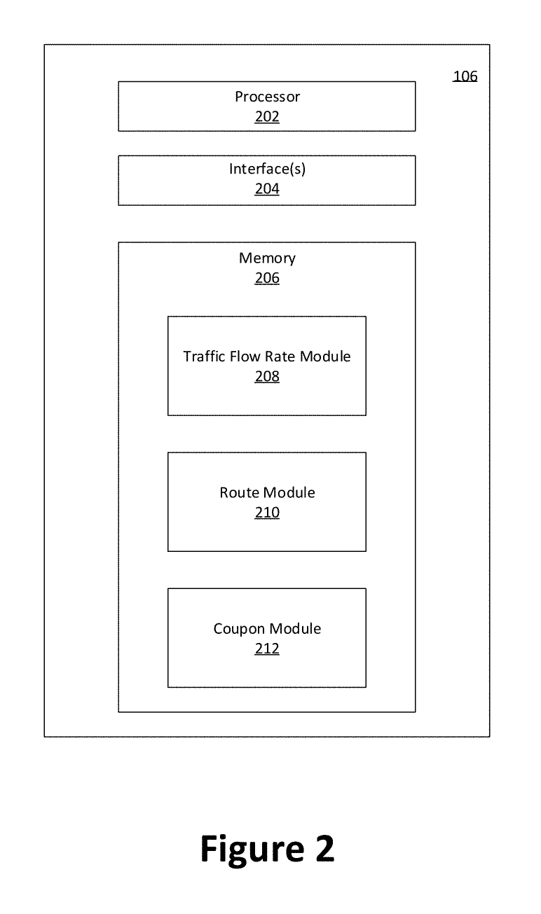

The traffic controller 106 can be communicatively coupled (e.g., via any known or to be developed wired and/or wireless network connection such as network 104) to one or more databases such as a sensor database 108 used to store data from the smart traffic camera 103 (and/or traffic sensor(s) 206, which will be discussed below with reference to FIG. 2), a traffic flow rate database 110 used to store traffic flow rates at different zones of the intersection 101 over one or more time intervals, a route database 112 used to store routes calculated to one or more destinations of an object detected at the intersection and a temporary coupon database 114 used to store coupons, promotions, advertisements, etc., retrieved from an external source or data base (e.g., coupon database 115-1, as will be described below) for association with one or more destinations and transmission thereof to the detected objects.

In one example, databases 108-114 described above may be associated with the traffic controller 106 and may be co-located with and co-operated with traffic controller 106. Alternatively, the databases 108-114 may be remotely located relative the traffic controller 106 and accessible via the network 104 as shown in FIG. 1.

Furthermore, system 100 may also include external database 115. External database 115 may include one or more databases such as coupon database 115-1 and store location database 115-2. The databases 115-1 and 115-2 may be provided by one or more third party vendors and include information about various merchants, sites, vendors and the products and services they offer as well as any related advertisements, discounts, coupons, promotions, sales, etc., offered by the respective one(s) of the merchants. External database 115 (and each of the databases 115-1 and 115-2 may be accessible by the traffic controller 106 via the network 114.

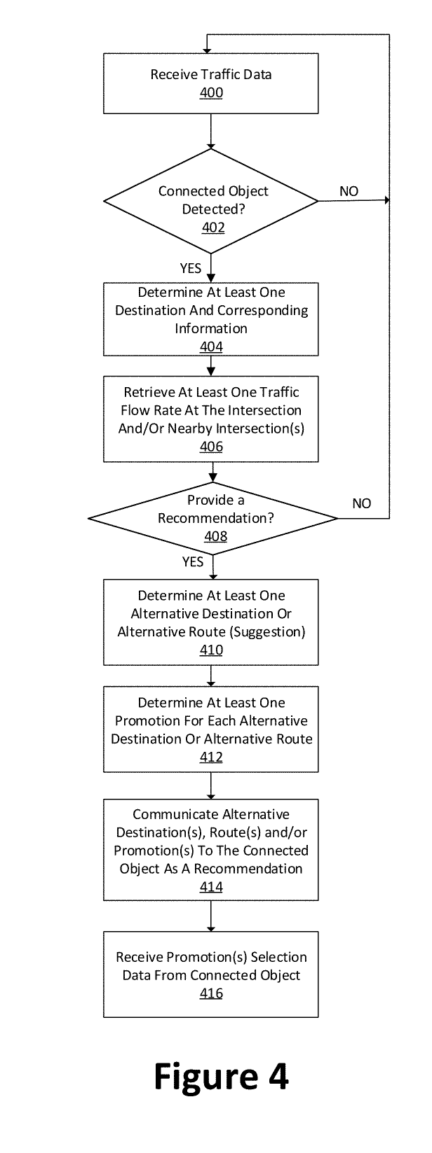

The use of databases 108-115 described above by the traffic controller 106 will be further described below with reference to FIG. 4.

Referring back to the traffic controller 106, the traffic controller 106 can provide a centralized platform for network operators to view and manage traffic conditions, set traffic control parameters and/or manually override any traffic control mechanisms at any given intersection. An operator can access and use the traffic controller 106 via a corresponding graphical user interface 116 after providing logging credentials and authentication of the same by the traffic controller 106. The traffic controller 106 can be controlled, via the graphical user interface 116, by an operator to receive traffic control settings and parameters to apply to one or more designated intersections. The traffic controller 106 can also perform automated and adaptive control of traffic at the intersection 101 or any other associated intersection based on analysis of traffic conditions, data and statistics at a given intersection(s) using various algorithms and computer-readable programs such as known or to be developed machine learning algorithms. The components and operations of traffic controller 106 will be further described below with reference to FIGS. 2-5.

Traffic controller 106 can be a cloud based component running on a public, private and/or a hybrid cloud service provided by one or more cloud service providers.

The system 100 can also have additional intersections and corresponding light controllers associated therewith. Accordingly, not only the traffic controller 106 is capable of adaptively controlling the traffic at an intersection based on traffic data at that particular intersection but it can further adapt traffic control parameters for that particular intersection based on traffic data and statistics at nearby intersections communicatively coupled to the traffic controller 106.

As shown in FIG. 1, the light controllers 118 can be associated with one or more traffic lights at one or more of the intersections 120 and can function in a similar manner as the light controller 102 and receive traffic control settings from the traffic controller 106 for managing traffic at the corresponding one of intersections 120. Alternatively, any one of the light controllers 118 can be a conventional light controller implementing pre-set traffic control settings at the corresponding traffic lights but configured to convey corresponding traffic statistics to the traffic controller 106.

The intersections 120 can be any number of intersections adjacent to the intersection 101, within the same neighborhood or city as the intersection 101, intersections in another city, etc.

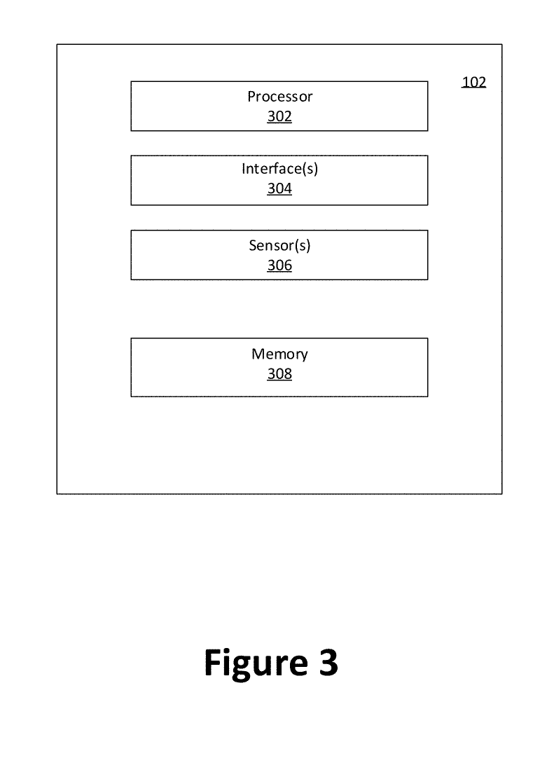

In one or more examples, the light controller 102 and the traffic controller 106 can be the same (one component implementing the functionalities of both). In such example, components of each described below with reference to FIGS. 2 and 3 may be combined into one. Furthermore, in such example, the light controller 102 may be remotely located relative to the smart traffic camera 103 and/or the traffic light 117 and be communicatively coupled thereto over a communication network such as the network 104.

As mentioned above, the components of the system 100 can communicate with one another using any known or to be developed wired and/or wireless network. For example, for wireless communication, techniques such as Visible Light Communication (VLC), Worldwide Interoperability for Microwave Access (WiMAX), Long Term Evolution (LTE), Fifth Generation (5G) Cellular, Wireless Local Area Network (WLAN), Infrared (IR) communication, Public Switched Telephone Network (PSTN), Radio waves, and other communication techniques known or to be developed in the art may be utilized.

While certain components of the system 100 are illustrated in FIG. 1, inventive concepts are not limited thereto and the system 100 may include any number of additional components necessary for operation and functionality thereof.

Having described components of an example system 100, the disclosure now turns to description of one or more examples of components of the traffic controller 106 and the light controller 102.

FIG. 2 is a block diagram showing different components of the traffic controller of FIG. 1.

The traffic controller 106 can comprise one or more processors such as a processor 202, interface(s) 204 and one or more memories such as a memory 206. The processor 202 may execute an algorithm stored in the memory 206 for managing traffic at intersections by providing recommendations and incentives to objects at the intersection to take alternative routes to their respective destinations. The processor 202 may also be configured to decode and execute any instructions received from one or more other electronic devices or server(s). The processor 202 may include one or more general purpose processors (e.g., INTEL® or Advanced Micro Devices® (AMD) microprocessors, ARM) and/or one or more special purpose processors (e.g., digital signal processors, Xilinx® System On Chip (SOC) Field Programmable Gate Array (FPGA) processor, and/or Graphics Processing Units (GPUs)). The processor 202 may be configured to execute one or more computer-readable program instructions, such as program instructions to carry out any of the functions described in this description.

The interface(s) 204 may assist an operator in interacting with the traffic controller 106. The interface(s) 204 of the traffic controller 106 can be used instead of or in addition to the graphical user interface 116 described above with reference to FIG. 1. In another example, the interface(s) 204 can be the same as the graphical user interface 116. The interface(s) 204 either accept an input from the operator or provide an output to the operator, or may perform both the actions. The interface(s) 204 may either be a Command Line Interface (CLI), Graphical User Interface (GUI), voice interface, and/or any other user interface known in the art or to be developed.

The memory 206 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

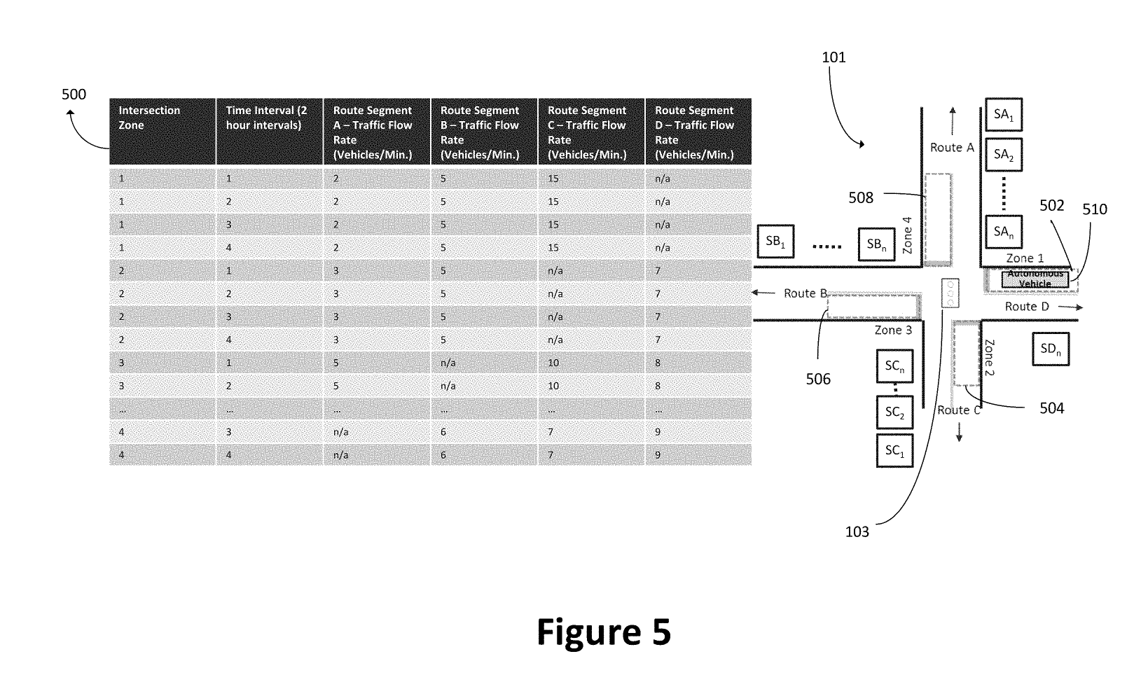

The memory 206 may include computer-readable instructions, which when executed by the processor 202 cause the traffic controller 106 to manage traffic at intersections by providing recommendations and incentives to objects at the intersection to take alternative routes to their respective destinations. The computer-readable instructions stored in the memory 206 can be identified as traffic flow rate module (service) 208, a route module (service) 210, and a coupon module (service) 212. The functionalities of each of these modules, when executed by the processor 202 will be further described below with reference to FIGS. 4 and 5.

FIG. 3 is a block diagram showing different components of the light controller of FIG. 1. As mentioned above, the light controller 102 can be physically located near the smart traffic camera 103 and/or the traffic light 117 (e.g., at a corner of the intersection 101) or alternatively can communicate with the smart traffic camera 103 and/or the traffic light 117 wirelessly or via a wired communication scheme (be communicatively coupled thereto).

The light controller 102 can comprise one or more processors such as a processor 302, interface(s) 304, sensor(s) 306, and one or more memories such as a memory 308. The processor 302 may execute an algorithm stored in the memory 308 for implementing traffic control rules, as provided by traffic controller 106. The processor 302 may also be configured to decode and execute any instructions received from one or more other electronic devices or server(s). The processor 302 may include one or more general purpose processors (e.g., INTEL® or Advanced Micro Devices® (AMD) microprocessors, ARM) and/or one or more special purpose processors (e.g., digital signal processors, Xilinx® System On Chip (SOC) Field Programmable Gate Array (FPGA) processor, and/or Graphics Processing Units (GPUs)). The processor 302 may be configured to execute one or more computer-readable program instructions, such as program instructions to carry out any of the functions described in this description.

The interface(s) 304 may assist an operator in interacting with the light controller 102. The interface(s) 304 of the light controller 102 may be used instead of or in addition to the graphical user interface 116 described with reference to FIG. 1. In one example, the interface(s) 304 can be the same as the graphical user interface 116. The interface(s) 304 either accept an input from the operator or provide an output to the operator, or may perform both actions. The interface(s) 304 may either be a Command Line Interface (CLI), Graphical User Interface (GUI), and/or any other user interface known in the art or to be developed.

The sensor(s) 306 can be one or more smart cameras such as fish-eye cameras mentioned above or any other type of sensor/capturing device that can capture various types of data (e.g., audio/visual data) regarding activities and traffic patterns at the intersection 101. Any one such sensor 306 can be located at/attached to the light controller 102, located at/attached to the smart traffic camera 103 and/or the traffic light 117 or remotely installed and communicatively coupled to the light controller 102 and/or the smart traffic camera 103 via the network 104.

As mentioned, the sensor(s) 306 may be installed to capture objects moving across the roads. The sensor(s) 306 used may include, but are not limited to, optical sensors such as fish-eye camera mentioned above, Closed Circuit Television (CCTV) camera and Infrared camera. Further, sensor(s) 306 can include, but not limited to induction loops, Light Detection and Ranging (LIDAR), radar/microwave, weather sensors, motion sensors, audio sensors, pneumatic road tubes, magnetic sensors, piezoelectric cable, and weigh-in motion sensor, which may also be used in combination with the optical sensor(s) or alone.

The memory 308 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The memory 308 may include computer-readable instructions, which when executed by the processor 302 cause the light controller 102 to implement traffic control rules as provided by traffic controller 106.

As mentioned above, light controller 102 and traffic controller 106 may form a single physical unit, in which case system components of each, as described with reference to FIGS. 1 to 3 may be combined into one (e.g., all example modules described above with reference to FIGS. 2 and 3 may be stored on a single memory such as the memory 206 or the memory 308).

While certain components have been shown and described with reference to FIGS. 2 and 3, the components of the light controller 102 and/or the traffic controller 106 are not limited thereto, and can include any other component for proper operations thereof including, but not limited to, a transceiver, a power source, etc.

Having described an example system and example components of one or more elements thereof with reference to FIGS. 1-3, the disclosure now turns to the description of examples for managing traffic at intersections based on detection of objects and communication of recommendations thereto.

As briefly mentioned above, traffic control systems are constantly evolving to provide better management and control of traffic (adaptive control) based on real-time conditions at an intersection or a collection of nearby intersections. With the advancement of car related technologies and more specifically interconnected cars such as autonomous vehicles, it is possible to provide further improvements by analyzing real time traffic conditions at the intersection and communicating with the connected vehicles to provide incentives to such vehicles to select alternative routes to other similar destinations in order to reduce traffic congestions at intersection(s). Example methods of achieving this objective will be described below with reference to FIG. 4.

FIG. 4 illustrates a flowchart of a method executed by the traffic controller of FIG. 1. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed example embodiments.

Furthermore, FIG. 4 will be described from the perspective of the traffic controller 106. However, it will be understood that the functionalities of the traffic controller 106 are implemented by the processor 202 executing computer-readable instructions stored on the memory 206 described with reference to FIG. 2.

At step 400, the traffic controller 106 may receive traffic data at the intersection 101. The traffic data may be collected by the smart traffic camera 103 and/or sensor(s) 206 of the light controller 102 and communicated over the network 104 to the traffic controller 106. Alternatively and when the traffic controller 106 is located at the intersection 101 (e.g., when the traffic controller 106 and the light controller 102 are the same), the traffic data collected by the smart traffic camera 103 and/or the sensor(s) 206 will be sent to the traffic controller 106 over any know or to be developed communication scheme such as the network 104 or a short range wireless communication protocol or a wired communication medium.

In one example, the traffic data can include any type of object present at the intersection including, but not limited to, pedestrians, cars, trucks, motor cycles, bicycles, autonomous transport/moving objects and vehicles. Furthermore, cars, trucks, buses and bikes can further be broken down into sub-categories. For example, cars can be categorized into sedans, vans, SUVs, etc. Trucks can be categorized into light trucks such as pickup trucks, medium trucks such as box trucks or fire trucks, heavy duty trucks such as garbage trucks, crane movers, 18-wheelers, etc.

In one example, traffic data can also include traffic data of other adjacent and/or nearby intersections provided via corresponding smart traffic lights or light controllers such as light controllers 118 of FIG. 1.

At step 402, the traffic controller 106 may determine if a connected object is detected in the received traffic data. A connected object may be an object capable of establishing communication with other electronic equipment in its surrounding including the smart traffic light 103, the light controller 102 and/or the traffic controller 106. Examples of connected objects may be a mobile device associated with a pedestrian, biker, driver, etc. detected at the intersection 101, an autonomous vehicle, a mobile device associated with a passenger of a moving object detected at the intersection 101, etc. Therefore, a connected object may refer to a mobile device or an interconnected vehicle such as an autonomous car.

In one example, the traffic controller 106 can detect a connected object if a communication including an object identifier is received from an object at the intersection 101. This identifier can be similar to a MAC address or an IP address of a network connected device.

If at step 402, the traffic controller 106 determines that no connected object is detected, the process reverts back to step 400 and steps 400 and 402 are repeated until a connected object is detected at the intersection 101 at step 402.

Thereafter, at step 404, the traffic controller 106 can determine at least one destination and corresponding information (if applicable) associated with the connected object. For example, the connected object such as a connected vehicle can have an on-board global positioning system (GPS), in which a driver of the connected vehicle has entered an address of a point of interest (a destination). The destination can be a store, a site, etc. In another example, the driver's mobile device may be connected to the connected vehicle from which a shopping list (an example of corresponding information) including a list of one or more items to be purchased at the destination may be retrieved. A shopping list and the destination (e.g., a grocery store) information may then be communicated by the connected object to the traffic controller 106. Alternatively, the destination and associated information may be communicated from the driver's mobile device directly to the traffic controller 106. In another example, the driver's or a bike rider's mobile phone may have a calendar thereon, indicating a scheduled event to which the rider or the driver is traveling and thus is detected at the intersection 101. Accordingly, from the scheduled event recorded in the rider/driver's calendar, the traffic controller 106 can determine the destination and any corresponding information.

In yet another example, the corresponding information need not be specified by the user (e.g., driver or rider) for the traffic controller to retrieve. Instead, by knowing the destination and knowing past behavior of the user (e.g., past travel route(s), stop(s), item(s) purchased, etc., in route to the same destination such as stopping at a convenient store to pick up beverages before attending a baseball game), the traffic controller 106 can deduce/determine information associated (e.g., items and stores of interest) with the destination to which the user is traveling.

At step 406, the traffic controller 106 retrieves current traffic flow rates at the intersection 101 from the traffic flow rate database 110. Additionally, at step 406, the traffic controller 106 can retrieve current traffic flow rates at other nearby intersections (e.g., intersection 120) from the traffic flow rate database 110 or directly from light controllers 118 (and/or any smart traffic cameras or sensors) installed at the corresponding ones of the intersections 120. The traffic controller 106 may determine traffic flow rates at different zones/routes of the intersection 101 and store them (in a tabular form) in the traffic flow rate database 110.

In one example, the traffic controller 106 can determine, by executing computer-readable instructions corresponding to the traffic flow rate module 208 stored on the memory 206, traffic flow rates. The traffic controller 106 can determine the traffic flow rates by tracking objects detected at the intersection 101 and calculating the number of objects entering and exiting different zones of the intersection 101 (e.g., based any known or to be developed methods of image/video processing for detecting object types in captured video/image data or using other known or to be developed techniques such as multiplying a predicted space mean speed (Vse) with a traffic density (k)). The traffic controller 106 can determine zone or route specific traffic flow rates and/or average traffic flow rate for the intersection 101. The traffic controller 106 can determine such traffic flow rates over one or more time intervals, duration of which is a configurable parameter that may be set by a network operator via the graphical user interface 116, for example, based on experiments and/or empirical studies.

FIG. 5 illustrates an example of a traffic flow rate table for an intersection. FIG. 5 illustrates a traffic flow rate table 500 for the intersection 101, which also has at least one traffic light 117 (not shown in FIG. 5 but shown and described with reference to FIG. 1 above). As shown in FIG. 5, the intersection 101 has four incoming zones, namely zone 1 502, zone 2 504, zone 3 506 and zone 4 508. An object such as an autonomous vehicle 510 may approach the intersection 101 through any of the zones 502-508 (e.g., through zone 1 502 in FIG. 5). The intersection 101 also has four exit routes indicated by route A, route B, route C and route D in FIG. 5.

Along each route, there may be one or more destinations (e.g., stores). Destinations along route A are indicated as SA₁ to SAₙ, with n being an integer greater than or equal to 2. Destinations along route B are indicated as SB₁ to SBₙ, with n being an integer greater than or equal to 2. Destinations along route C are indicated as SC₁ to SCₙ, with n being an integer greater than or equal to 2. In some examples, there may be only a single destination along a route such as destination SDₙ along route D.

Table 5 includes traffic flow rates for each of the zones 502-508 (indicated by zone numbers 1-4 in table 500). As can be seen from FIG. 5, incoming traffic from any given zone (e.g., autonomous vehicle 510 through zone 1 502) can exit the intersection through route A, B and C but not route D (assuming no U-turn is allowed at the intersection 101). In another example, the autonomous vehicle 510 can also exit through route D.

Table 500 includes, for each zone, traffic flow rate data for four different time intervals (time intervals 1-4). For each time interval and for each possible exit from a given entry zone, a corresponding traffic flow rate is provided in table 500. For example, for zone 1 502, during time interval 1, traffic flow rate from exit route A is 2 vehicles/min, from exit route B is 5 vehicles/min and from exit route C is 15 vehicles/min. However, a traffic flow rate for autonomous vehicle 510 through exit route D is not applicable (n/a).

In the example of FIG. 5 traffic flow rates are maintained in table 500 for only 4 time intervals, where each interval has a duration (e.g., 30 seconds, 1 minute, 15 minutes, 30 minutes, an hour, etc.). However, inventive concepts are not limited thereto. For example, table 500 may retain only the traffic flow rates for only one or two most recent time interval, for 10 most recent intervals or any other number of most recent intervals.

Referring back to FIG. 4, at step 408 and based on or more of the retrieved traffic flow rates at the intersection 101, traffic flow rates at other intersections such as the intersections 120) and the determined destination of the detected connected object, the traffic controller 106 determines whether to provide a recommendation (alternative route to alternative destination(s) that can be accompanied by an incentivizing promotion or message) to the connected object or not. For example, if the autonomous vehicle 510 (e.g., an example of a connected car detected at step 400) approaches the intersection 101 through zone 1 502 and is heading toward the destination SA₁ on route A, the traffic controller 106, by referencing the table 500 stored in the flow rate database 110, can determine that the average traffic flow rate along the exit on route A, over the four most recent time intervals is 2 vehicles/min, which is equal to or less than a threshold (e.g., 7 vehicles/min). Therefore, the traffic controller 106 determines that a recommendation (including an alternative destination, a corresponding route and a corresponding promotion) is to be provided to the autonomous vehicle 510.

However, if the autonomous vehicle 510's destination, determined at step 406, is destination SC₁, the traffic controller 106, by referencing the table 500 stored in the flow rate database 110, can determine that the average traffic flow rate along the exit on route C, over the four most recent time intervals is 15 vehicles/min, which is greater than the threshold (e.g., 7 vehicles/min). Therefore, the traffic controller 106 determines that a recommendation for the autonomous vehicle 510 need not be provided.

In one example, instead of looking at a particular average traffic flow rate at the intersection 101 (e.g., over 4 time intervals), the traffic controller 106 can simply look at the traffic flow rate over the most recent time interval or any number of recent time intervals or an average traffic flow rate for the entire intersection 101.

In one example, the threshold is a configurable parameter that may be determined based on experiments and/or empirical studies either automatically by the traffic controller 106 (e.g., based on historical traffic patterns at the intersection 101 considering time of day, scheduled events, traffic conditions at other adjacent or nearby intersections, etc.) or may be manually specified by a network operator through, for example, the graphical user interface 116 associated with the traffic controller 106.

If at step 408, the traffic controller 106 determines that a recommendation is not needed (based on one or more traffic flow rates at the intersection 101 and a destination of the connected car), the process reverts back to step 400 and the traffic controller 106 repeats steps 400 to 406.

However, if at step 408, the traffic controller 106 determines that a recommendation is needed, then at step 410, the traffic controller 106 determines at least one alternative destination for the user (passenger, driver, rider) of the detected connected car or an alternative route to the same destination (e.g., a suggestion) by executing computer-readable instructions stored on the memory 206 of the traffic controller 106 corresponding to the route module 210. For example, if the destination determined at step 404 is a particular grocery store for which the user has to travel through the intersection 101 (and the current traffic flow rate to the destination at the intersection 101 is equal to or less than a threshold), then at step 410, the traffic controller 106 can determine at least one alternative grocery store which the user can visit to obtain one or more (or all of) items on a user's list as received by the traffic controller as part of associated information at step 406. Accordingly, the connected object and consequently the user can avoid traveling through the intersection 101. In one example, the traffic controller 106 can determine the at least one alternative grocery store or more generally the at least one alternative destination by querying the store database 115-2, which has information including geographical information associated with various merchants, sites, etc., and their corresponding categories.

In one example, the traffic controller 106 can also determine a travel route and/or a travel time for each alternative destination. In one example and for a given alternative destination, the traffic controller can determine several routes thereto as well as different travel time along each route to arrive at the alternative destination. The alternative routes and corresponding travel times may be determined using a mapping database maintained by the traffic controller 106 or by referencing external GPS and mapping databases that are publicly available or may be accessed after obtaining a subscription thereto.

In one example, instead of determining an alternative destination at step 408, the traffic controller 106 can determine an alternative route to the same destination and select a promotion that may incentive the connected object and the associated user to take the alternative route to the same destination (e.g., take route C instead of route A to store SA₁ as shown in FIG. 5 and in exchange receive a 10% discount).

In one example, the store database 115-2 may be configured to store location of various places such as retailers, restaurants, retail outlets, attractions, malls, grocers, museums, restaurants, parks, and/or other businesses that sell goods and/or services (having corresponding store IDs). The location database 115-2 may store an address of a current destination of the autonomous vehicle or a connected object detected at step 402. In one case, the store database 115-2 may be configured to store an alternative destination for the autonomous vehicle. For example, the store location database 115-2 may store different stores along a specific route. In an example, the store location database 115-2 may store specific location data, a type of store or retailer, etc. For example, as shown below in Table 1, the store location database 112 may store different stores along a specific route. Table 1 illustrates only four sample routes and store IDs of FIG. 5 for ease of discussion but inventive concepts are not limited thereto.

In addition, Table 1 can also include a column in which alternative store IDs corresponding to a given store ID are stored. For example, in association with store ID SA₁, there may be several other store IDs stored that may represent merchants, sites, destinations that offer similar products or services as store ID SA₁ and may be selected as alternative destination(s) by the traffic controller 106 to be presented to the user of the connected object (e.g., the autonomous vehicle 510). As can be seen from the alternative store IDs in Table 1, the alternative stores may be along routes of the same intersection 101 or at other routes along other intersections or any other geographical location.

TABLE 1
Different stores along a specific route with corresponding alternative
destinations stored in store database 115-2

| Route | Store ID | Alternative Store ID |
|---|---|---|
| A | SA₁ | SG₁, |
| | | SF₁ |
| A | SA₂ | SP₆ |
| B | SB₁ | SC₁, |
| | | SN₁ |
| | | SJ₄ |
| B | SB₂ | SQ₁ |

At step 412, the traffic controller 106 can execute computer-readable instructions corresponding to the coupon module 212 stored on the memory 206 to determine at least one promotion associated with each alternative destination determined at step 410, each alternative route to each alternative destination or each alternative route to the same original destination determined at step 406. In doing so, the traffic controller 106 can query the external coupon database 115-1 to retrieve available promotions for each alternative destination determined at step 410. The promotions may include, but are not limited to, a coupon, a sale notification, a promotion, a gift card, etc.

The coupon database 115-1 may be configured to store coupons, advertisements or discounts for any number of retailers, retail outlets, sites, merchants, virtual/online stores and/or physical stores, represented by a corresponding coupon ID. In one case, the coupon database 115-1 may store a coupon related to an alternative destination as shown in Table 2 and/or alternatively with reference to a corresponding alternative route (to the same/original destination of the connected object or the alternative destination). In one case, the coupon may be used at an alternative destination by an autonomous vehicle or a user of a connected object. Table 2 shows some example coupon IDs associated with 4 of the example alternative destinations of Table 1. The coupon database 115-1 may also store coupons for each route at different time intervals. In one case, the time intervals may be represented by a time of day or may be the same as the time intervals described above with reference to table 500 of FIG. 5. For example, as shown below in Table 2, the coupon database 110 may store different coupons for different 2-hour time interval. Accordingly, available coupons in Table 2 may dynamically change depending on time of day, day of week, etc.

TABLE 2
Different coupons for different routes stored in the coupon database 110.

| Time | | | | |
|---|---|---|---|---|
| interval | | | | |
| (2 hour | SG₁ - | SP₆ - Coupon | SN₁ - | SQ₁ - Coupon |
| intervals) | Coupon IDs | IDs | Coupon IDs | IDs |
| 1 | Coupon 1 | Coupon 5 | Coupon 9 | Coupon 13 |
| 2 | Coupon 2 | Coupon 6 | Coupon 10 | Coupon 14 |
| 3 | Coupon 3 | Coupon 7 | Coupon 11 | Coupon 15 |
| 4 | Coupon 4 | Coupon 8 | Coupon 12 | Coupon 16 |

In one example and upon querying the coupon database 115-1, the traffic controller 206 may store the retrieved coupons in the temporary coupon database 114.

In one example, the temporary coupon storage database 114 may represent a memory for holding coupon data from the coupon database 115-1. In an example, the temporary coupon storage database 114 may store a current coupon record (i.e., a most recent coupon). The current coupon record may be written over old data. In one case, the temporary coupon storage database 114 may store a coupon related to an alternative destination and/or corresponding alternative route for reaching the alternative destination. For example, as shown below in Table 3, the temporary coupon storage database 114 may store different coupons related to the alternative route.

TABLE 3
Different coupons stored in the temporary coupon storage database 114.

| Time interval (2 hour | | |
|---|---|---|
| intervals) | Coupon IDs | Alternative Store IDs |
| 1 | Coupon 1 | SG₁ |
| 2 | Coupon 2 | SG₁ |
| 3 | Coupon 3 | SG₁ |
| 4 | Coupon 4 | SG₁ |
| 1 | Coupon 5 | SP₆ |
| 2 | Coupon 6 | SP₆ |

Upon determination of alternative route(s) and corresponding promotions at steps 410 and 412, at step 414, the traffic controller 106 can communicate the alternative route(s) and corresponding promotions to the connected object (communicate the recommendation). This communication may be based on any known or to be developed wireless communication. The communication may be directly to the connected object (e.g., the connected vehicle) or alternatively be to a mobile device associated with a user of the connected vehicle or simply a mobile device of a user detected at the intersection 101 as an object or traveling in an object that is not necessarily a connected object.

Optionally, at step 416 and upon selection of one alternative destination and corresponding promotion, the traffic controller 106 may receive a corresponding indication (promotion selection data) from the connected object and transmit the same to external databases 115. Such data may be used by external vendors and or merchants registered therewith to determine a rate of conversion of advertisements for future use of the system, etc.

Example embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e. g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A method comprising:
detecting an object at an intersection;
determining at least one destination associated with the object;
based on at least one traffic flow rate at the intersection and the at least one destination, determining a suggestion for the object, the suggestion including one of (1) at least one alternative destination and a corresponding travel route or (2) at least one alternative route to the at least one destination;
selecting a corresponding promotion for the suggestion; and
communicating, as a recommendation, the suggestion and the corresponding promotion to the object.

2. The method of claim 1, further comprising:
determining if the at least one traffic flow rate at the intersection for reaching the at least one destination is equal to or less than a corresponding threshold; and
determining the suggestion if the one or more traffic flow rates is equal to or less than the corresponding threshold.

3. The method of claim 1, wherein the object is an autonomous vehicle.

4. The method of claim 1, further comprising:
identifying a plurality of zones at the intersection;
receiving from at least one sensor at the intersection, information regarding current traffic conditions at the intersection; and
for each of the plurality of zones, determining a corresponding traffic flow rate to be used as the one or more traffic flow rates for determining the suggestion.

5. The method of claim 1, wherein the corresponding promotion is retrieved from an external database that stores promotions for available destinations.

6. The method of claim 1, further comprising:
receiving, from the object and in addition to the at least one destination, a list of items to be purchased at the at least one destination, the suggestion being based on the list of items.

7. The method of claim 1, wherein determining the suggestion is further based on at least one flow rate at one or more nearby intersections.

8. A device comprising:
memory having computer-readable instructions stored therein; and
one or more processors configured to execute the computer-readable instructions to:
detect an object at an intersection;
determine at least one destination associated with the object;
based on at least one traffic flow rate at the intersection and the at least one destination, determine a suggestion for the object, the suggestion including one of (1) at least one alternative destination and a corresponding travel route or (2) at least one alternative route to the at least one destination;
select a corresponding promotion for the suggestion; and
communicate, as a recommendation, the suggestion and the corresponding promotion to the object.

9. The device of claim 8, wherein the one or more processors are configured to execute the computer-readable instructions to:
determine if the at least one traffic flow rate at the intersection for reaching the at least one destination is equal to or less than a corresponding threshold; and
determine the suggestion if the one or more traffic flow rates is equal to or less than the corresponding threshold.

10. The device of claim 8, wherein the object is an autonomous vehicle.

11. The device of claim 8, wherein the one or more processors are configured to execute the computer-readable instructions to:
identify a plurality of zones at the intersection;
receive from at least one sensor at the intersection, information regarding current traffic conditions at the intersection; and
for each of the plurality of zones, determine a corresponding traffic flow rate to be used as the one or more traffic flow rates for determining the suggestion.

12. The device of claim 8, wherein the corresponding promotion is retrieved from an external database that stores promotions for available destinations.

13. The device of claim 8, wherein the one or more processors are configured to execute the computer-readable instructions to:
receive, from the object and in addition to the at least one destination, a list of items to be purchased at the at least one destination, the suggestion being based on the list of items.

14. The device of claim 13, wherein the one or more processors are configured to execute the computer-readable instructions to further determine the suggestion based on at least one flow rate at one or more nearby intersections.

15. One or more non-transitory computer-readable medium having computer-readable instructions stored thereon, which when executed by one or more processors, cause the one or more processors to:
detect an object at an intersection;
determine at least one destination associated with the object;
based on at least one traffic flow rate at the intersection and the at least one destination, determine a suggestion for the object, the suggestion including one of (1) at least one alternative destination and a corresponding travel route or (2) at least one alternative route to the at least one destination;
select a corresponding promotion for the suggestion; and
communicate, as a recommendation, the suggestion and the corresponding promotion to the object.

16. The one or more non-transitory computer-readable medium of claim 15, wherein the execution of the computer-readable instructions by the one or more processors, cause the one or more processors to:
determine if the at least one traffic flow rate at the intersection for reaching the at least one destination is equal to or less than a corresponding threshold; and
determine the suggestion if the one or more traffic flow rates is equal to or less than the corresponding threshold.

17. The one or more non-transitory computer-readable medium of claim 15, wherein the object is an autonomous vehicle.

18. The one or more non-transitory computer-readable medium of claim 15, wherein the execution of the computer-readable instructions by the one or more processors, cause the one or more processors to:
identify a plurality of zones at the intersection;
receive from at least one sensor at the intersection, information regarding current traffic conditions at the intersection; and
for each of the plurality of zones, determine a corresponding traffic flow rate to be used as the one or more traffic flow rates for determining the suggestion.

19. The one or more non-transitory computer-readable medium of claim 15, wherein the execution of the computer-readable instructions by the one or more processors, cause the one or more processors to further determine the suggestion based on at least one flow rate at one or more nearby intersections.

20. The one or more non-transitory computer-readable medium of claim 15, wherein the execution of the computer-readable instructions by the one or more processors, cause the one or more processors to:
receive, from the object and in addition to the at least one destination, a list of items to be purchased at the at least one destination; and
determine the suggestion based on the list of items.
